(19) United States
(12) Patent Application Publication
(10) Pub. No.: US 2002/0198805 A1
(43) Pub. Date: Dec. 26, 2002

(54) Method and apparatus for optimizing taxes in a transaction

(76) Inventor: Roger Burkhardt, Irvington, NY (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/155,848

(22) Filed: May 24, 2002

Related U.S. Application Data
(60) Provisional application No. 60/293,245, filed on May 24, 2001.

(51) Int. Cl. G06F 17/60

(52) U.S. Cl. 705/35

(57) ABSTRACT

A method and apparatus optimizes tax treatment of business transactions by determining in advance the taxes that would be due in each of several possible jurisdictions. Once the tax results are presented to the user, the user can select in which jurisdiction to execute the transaction. Once the jurisdiction is selected, information regarding execution of the transaction is forwarded to a computer located in the selected jurisdiction and the transaction is then executed in the computer in the selected jurisdiction. The method and apparatus help conduct business transactions electronically over an internationally operated distributed computer network, such as the Internet, and execute the transaction in a jurisdiction selected to minimize the taxes while transferring the money and assets, rights or liabilities from the parties in jurisdictions in which the money and assets, rights or liabilities are located.

### STATEMENT OF RELATED APPLICATION

This application claims priority to U.S. Provisional Patent Application No. 60/293,245 filed May 24, 2001, entitled “Method and Apparatus for Optimizing Taxes in a Transaction.”

### FIELD OF THE INVENTION

The invention described herein relates generally to methods and apparatuses for conducting business transactions electronically, and more particularly to a method and apparatus for conducting business transactions electronically via a distributed computer network operated internationally.

### BACKGROUND OF THE INVENTION

The present invention is therefore directed to the problem of developing a method and apparatus for optimizing tax effects in a business transaction.

### SUMMARY OF THE INVENTION

The present invention solves these and other problems by providing a method and apparatus for conducting business transactions electronically over an internationally operated distributed computer network, such as the Internet, and executing the transaction in a jurisdiction selected to minimize the taxes while transferring the money and assets, rights or liabilities from the parties in jurisdictions in which the money and assets, rights or liabilities are located.

### BRIEF DESCRIPTION OF THE DRAWINGS

FIG. 1 depicts an exemplary embodiment of a method for performing a business transaction according to one aspect of the present invention.

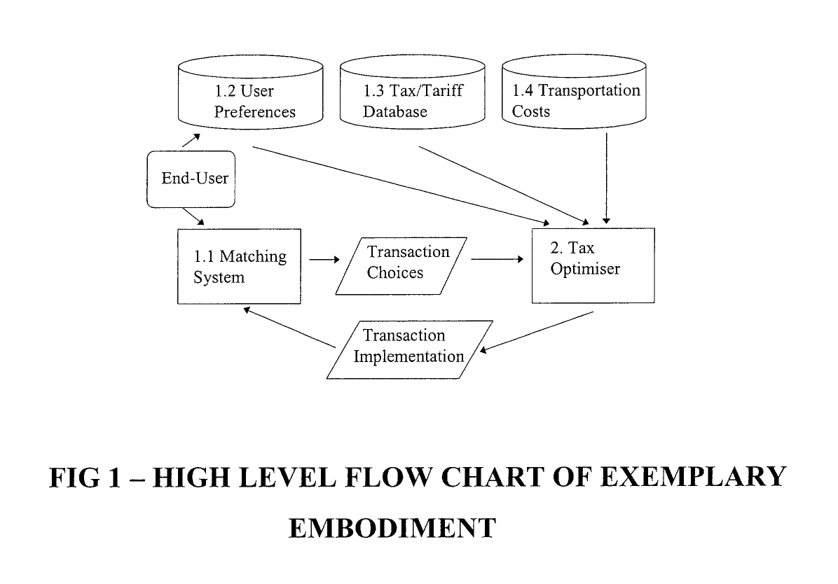

FIG. 2 depicts an exemplary embodiment of a method for optimizing the tax treatment of a transaction according to one aspect of the present invention.

FIG. 3 depicts an exemplary embodiment of an apparatus for optimizing the tax treatment of a transaction according to another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Exemplary Embodiment

This embodiment of one aspect of the present invention provides a tax optimization process that uses computer software and networks to reduce taxes due on a broad variety of electronic commerce or electronic transactions. This embodiment explores options available to users of the system and a comprehensive database of taxes and tariffs to both provide optimized transactions or alternatives to the optimal transaction depending upon the user preferences.

A computerized business process can be supplied as a service to matching systems across a full range of electronic commerce—from business-to-consumer (“B2C”) to business-to-business (B2B) and from simple online purchasing through periodic auctions to real-time exchanges. The “application service provider (ASP)” model allows a business focus on the core value proposition of reducing tax and tariff costs. The tax optimization service can also be provided as an online service to supplement traditional commerce, i.e. to allow an intermediary to reduce the tax costs of implementing a transaction that they have arranged between a buyer and a seller.

Inputs to Tax Optimizer Embodiment

There are four major input categories to the Tax Optimizer. Some of these may be obtained from vendors or partners to support a business model that is highly scalable across different industries and tax jurisdictions.

Matching System

The matching system may be one of many different categories of electronic marketplaces that match buyers and sellers. The participants may be businesses or consumers and the matches may be one to one, one to many or many to many. (See “B2B Exchanges” by Woods and Sculley pp 59-92 for a discussion of those categories that apply to the business-to-business subset).

The matching system passes the provisional set of transaction matches to the Tax Optimizer. This may consist of one business match that requires an optimal implementation or a set of potential matches that will be costed and ranked by the Tax Optimizer for subsequent final choice by the Matching System.

In either case the Matching System will pass information for each potential match that includes at least:

1. Identification for the buyer and seller.

2. Identification of the good or service (ideally using a standardized system such as UPC codes—see www.uc-council.org).

3. The price and quantity.

4. Source and delivery addresses.

5. Weight, dimensions and other data required for transportation cost estimation.

In a traditional commerce environment these values would be entered by the intermediary into computer screens provided by the tax optimization service.

User Tax Preferences and Alternatives

Additional information is required which may be collected by the Matching System or if it is not available may be collected by a separate set of business processes. The separation of these processes allows the Tax Optimization service to be offered as a complementary service to users of many different Matching Systems. This provides business flexibility to the providers of the Tax Optimization service and matching service and provides convenience to users of these services because their tax preferences are stored and managed by one trusted service. Collection of the user preferences is a straightforward matter of a set of computer screens that take a user through a dialog that collects their preferences and stores them in a database. This would be probably implemented using Internet technologies to allow for broad-based access.

In sophisticated business applications, the business's tax advisor can enter the information. In some cases this data would be confidential and sensitive and could be protected by being stored in an appropriate jurisdiction and/or by being stored under attorney client privilege.

User Alternatives

Users would specify the allowable alternatives (or constraints) for their transactions. These may be global or specified for a specific Matching System or even as a function of the good or service within that scope. For users who operate in multiple geographies then data would be collected for each applicable one. Delivery and source addresses will be physical locations or in the case of digitally delivered products they will be internet addresses.

1. Delivery addresses.

2. Source locations.

3. Allowable legal entities (for businesses with a number of different entities).

4. Jurisdictions for the consummation of the transaction.

5. Jurisdictions for the clearing and settlement of the transaction (if they can be separated from #3).

Tax Preferences

users would indicate the types of taxes that they wished to minimize or avoid altogether with a yes or no flag, supplemented by a weighting scheme where certain taxes are more or less onerous. For example if 50% of sales tax can be recaptured through other means then it would be weighted by that amount whereas other tax savings would have a 100% weighting.

1. Sales tax.

2. Value Added Tax.

3. Transaction Tax

4. Tariffs.

5. Quota compliance.

Each of the alternatives would have optional attributes that indicate the cost saving threshold that their use must pass for the user to accept their use. This may be entered as a percentage or an absolute amount and may be gross or net of other costs (for example additional shipping charges generated by the use of a different delivery method). In some applications the user will also specify other constraints such as the total transportation time.

Taxes, Tariffs and Quotas

Tax Rates:

A comprehensive database of tax rates by jurisdiction is provided, which database includes: sales taxes, use taxes, value added taxes and other transaction taxes such as stamp duties. These are a function of a number of data items captured above such as the type of good or service.

Tariffs

A comprehensive database of tariffs and customs duties applicable to different source (sales) and delivery locations for goods and services is provided.

Quotas and other Regulatory Constraints

Additionally, some goods such as steel are subject to quotas, which need to be complied with. This compliance can be automated as part of this system.

Transportation and Other Linked Costs

Tax minimization cannot be performed without addressing the other linked costs involved such as transportation. For example a business might wish to save on sales tax by having deliveries made to a warehouse A in one state rather than to Warehouse B in another, but only if the savings outweigh the incremental transportation costs of shipping to A rather than to B.

A database of transportation costs between the source, delivery (and possibly intermediate) locations. This could be provided by links with one or more vendors such as UPS or Federal Express.

In the case of a value added tax regimes, optimization would suggest where to add different elements (and assessed amounts) of value.

The Tax Optimization Process

The optimizer follows a logical sequence of steps to create an optimal implementation of the particular business transaction. The mathematical approach described below for explanatory purposes is that of an exhaustive search and for many applications the number of implementation options per transaction will be readily enumerated and calculated. For highly complex applications of the tax optimizer other standard mathematical optimization techniques will be applied to reduce the resources required to make the calculation.

Option Enumeration

For each potential transaction the optimizer looks up the user's preferences and enumerates options for the transaction. A simple case would be where the only difference is the delivery location where the buyer has two residences.

Tax Calculation

Tax is calculated for the various options enumerated above by using the rules in the tax database. This could, for example include a sales tax and an import duty on a consumer purchase. In cases where import quotas apply they would be calculated here.

Calculation of Other Costs

If different delivery points were being compared then transportation costs would be calculated using a representative vendor's database.

Ranking Recommendations

The Tax optimizer will propose a ranking based on the lowest cost approach subject to the user's preferences. For example the buyer may have requested the use of the second choice delivery location only where there is at least a $100 saving.

Sensitivity Calculation and Additional Option Generation

This is an optional step where the system analyzes the relative impact of different taxes and generates additional options to reduce the most onerous taxes and then feeds them back into the Tax calculation step.

Direct Feedback to Users

This is an optional step in the process where the user is fed back the ranking recommendations and invited to change their preferences or override them for the purpose of this transaction. It does require an interactive communication with the user, which presumes a business agreement to do so and a software handoff between the Matching system and the tax optimizer.

Feedback to the Matching System

The Tax optimizer passes back to the Matching system the recommended implementation of the transaction together with the estimated taxes and tariffs that need to be collected. If the Matching system supports different jurisdictions for the match to be performed then the implementation will include the routing instructions for this.

For example the buy and sell sides of the transaction can be routed to a tax-neutral jurisdiction to be matched and (for digital content) to be delivered (electronically). Bermuda is an example of a tax neutral jurisdiction where legislation explicitly confirms that local jurisdiction applies for transactions matched on a computer on the island.

Billing for Tax Services

The tax optimizer will bill the transaction system for the service provided. This may be a combination of a number of charges: subscription, transaction based, tax savings participation etc.

Sales of Tax Market Data

The tax optimizer will use aggregate data on usage of the system to produce and sell reports showing the revenue impact of various taxation approaches to the tax authorities.

Examples of Transactions

All these examples below presume a purchase or “trade” online that is then passed by the business responsible for the transaction to the tax optimization service to provide additional value added processing.

### EXAMPLE 1

### Large Consumer Purchase Online

John buys a diamond for Susan for $5,000 dollars at “Diamonds4You.com”. John lives in New York where there is an 8.25% sales tax and his parents have a home in Connecticut where there is none.

Diamonds4You.com offers John the opportunity to use Tax Optimization service and then passes the details of the transaction including total price and the NY delivery address he had requested to the TaxOptiMiser service. Diamonds4You.com shares the fact that it has no nexus for tax purposes in Connecticut.

John hasn't used the service before so the TaxOptiMiser system only has the information that Diamonds4You has passed to it.

The TaxOptiMiser system consults the tax rule data base and establishes that there is an 8.25% liability, it informs him of the $412.50 tax liability and asks him what other addresses he would consider using and about his willingness to incur any on-shipment costs and delays.

John shares his Connecticut address and says he would be prepared to put up with a 5-day delay if the savings were at least $100.

The system uses its transportation cost database and recommends sending the diamonds to his parents' house for an additional shipping cost of $25 plus an optional insurance of $50. John accepts the recommendation and the TaxOptiMiser system passes the new shipping address back to Diamonds4You. It arranges the shipping and insurance leveraging its larger buying power and sends the on-shipment insurance details to John's mother after querying him for his preferred delivery method: e-mail, fax or hardcopy.

### EXAMPLE 2

### Small Consumer Purchase online

John buys $100 of office supplies at “OfficeBasics.com” and he is passed to TaxOptiMiser whith details of his transaction. The system uses his profile to analyze the transaction and informs him that the sales tax savings to be gained by sending the supplies to his parents' house do not meet his savings hurdle of $100 and would cost $30 in shipping costs.

It asks him if the supplies are for business, tax preparation or personal purposes pointing out that in the former two cases he may be able to claim a deduction worth $28 at a 28% tax rate. John shares his actual marginal rate of 39% and signs up for a 50 c micro-service that e-mails the receipt with the relevant tax rules and instructions to his accountant.

### EXAMPLE 3

### Transaction Taxes for Auctions

Bertrand lives in EuroLand and enjoys buying and selling antiques on eauction.com. Transactions within EuroLand with a value of over 100 Euros are subject to a 2% transaction tax to be paid by the seller.

He finds a buyer for a larger than usual sale of Limoge plates for 1500 Euros and e-auction.com passes him to TaxOptimiser which informs him that he can avoid the 30 Euro transaction fee by having the transaction occur outside of the EuroLand jurisdiction.

It proposes sending the buyer and seller details to a matching service in Bermuda that will consummate the transaction under Bermudan Law where no tax is liable. (Bermuda's e-commerce code explicitly states that transactions executed on computer servers located in Bermuda are within its jurisdiction.) The buyer and seller will split the savings and e-auction.com will provide its customary ancillary services (eescrow etc) for an already established transaction.

Buyer and seller will arrange shipping details with each other either on TaxOptiMiser or on e-auction.com, which will be acting purely in a “post-trade” facilitation capacity.

### EXAMPLE 4

### Consumer Purchase of Software

John shops online for a computer aided design program for his engineering business at “rocketscientist.com”. The software costs $1000 and is available on CD or as a downloaded file for a slight discount. John is passed to TaxOptiMiser, which establishes that this is a business expense for his NY based business. It offers John the option of downloading the file from an offshore location run by an affiliate of rocketscientist.com to avoid sales taxes, which he accepts.

Exemplary Embodiments

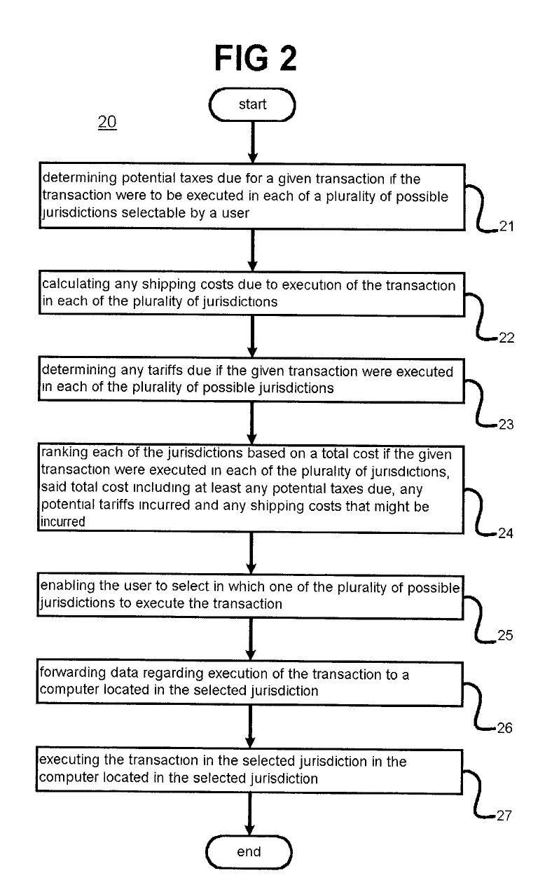

Referring to FIG. 2, shown therein is an exemplary embodiment of a method for optimizing tax treatment of a transaction. First, the method determines potential taxes due for a given transaction if the transaction were to be executed in each of several possible jurisdictions selectable by a user (step 21). This is accomplished by accessing a database storing the taxes in each of the possible jurisdictions and calculating the taxes due on a hypothetical transaction similar to the proposed transaction.

Next, the method calculates any shipping costs due to execution of the transaction in each of the jurisdictions (step 22). This is accomplished by determining what the shipping needs would be for the proposed transaction based on an execution in each of the possible jurisdictions and accessing a database storing shipping information and costs.

Next, the method determines what tariffs if any would be due if the given transaction were executed in each of the possible jurisdictions (step 23). This is accomplished by determining what border crossing would occur for the proposed transaction based on an execution in each of the possible jurisdictions and accessing a database storing tariff information.

Next, the method ranks each of the jurisdictions based on a total cost if the given transaction were executed in each of the possible jurisdictions (step 24). The total cost includes at least any potential taxes due, any potential tariffs incurred and any shipping costs that might be incurred. This ranking can include a relative score and other differentiating information, including color and size.

Next, the method enables the user to select in which one of the possible jurisdictions to execute the transaction (step 25). This can be accomplished by clicking on a jurisdiction in the ranking or list.

Next, the method forwards data regarding execution of the transaction to a computer located in the selected jurisdiction (step 26). This is accomplished by forwarding instructions regarding how to execute the transaction, such as an order to transfer funds from one account to another and other instructions necessary to execute the transaction in the selected jurisdiction.

Finally, the method executes the transaction in the selected jurisdiction in the computer located in the selected jurisdiction (step 27). This can be accomplished by sending a debit note to a specified account and sending a credit note to another account, thereby causing funds to transfer in the computer in the given jurisdiction, while also transferring title of the property or res of the transaction from one party to another in the jurisdiction selected by the user.

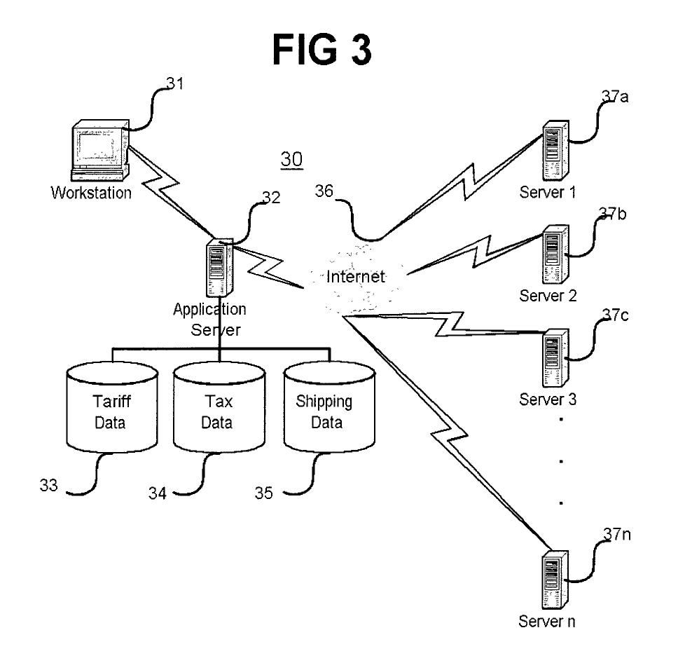

Turning to FIG. 3, shown therein is an apparatus for performing the above described methods for optimizing tax treatment of a transaction. A user interface 31, which is shown here symbolically as a workstation, enables a user to enter a proposed transaction and a several possible jurisdictions in which the transaction may be executed. A database 34 stores tax rules for multiple jurisdictions. Another database 33 stores tariff rules, while yet another database 35 stores shipping costs and related information. Each of these databases 33-35 is accessible by an application server 32 executing the methods described above. A processor in the server 32 accesses the tax database 34 to determine taxes that would ensue if a proposed transaction were to be executed in each of the possible jurisdictions, and outputs the taxes for each jurisdiction to the user interface 31.

Multiple servers 37a-n are accessible via the Internet 36 by the processor. Each of the servers 37a through 37n are disposed in one of the jurisdictions, i.e., there is one server for each of the jurisdictions. One of the servers 37a-n matches two sides of the transaction in a selected jurisdiction upon instructions by the user. The processor in the application server determines any tariffs that might be due if the given transaction were executed in each of the possible jurisdictions, as well as calculating any shipping costs due if the transaction was executed in each of the possible jurisdictions. The processor then ranks each of the possible jurisdictions based on a total cost if the given transaction were executed in each of the possible jurisdictions. The total cost includes at least any potential taxes due, any potential tariffs incurred and any shipping costs that might be incurred.

Although various embodiments are specifically illustrated and described herein, it will be appreciated that modifications and variations of the invention are covered by the above teachings and within the purview of the appended claims without departing from the spirit and intended scope of the invention. For example, while several of the embodiments depict the use of specific data management and interface standards, other data management and interfaces will suffice. Moreover, while specific program and protocols are included, other protocols (including subsequently developed protocols) may be sufficient to implement the embodiments described herein. These examples should not be interpreted to limit the modifications and variations of the invention covered by the claims but are merely illustrative of possible variations.

What is claimed is:

1. A method for optimizing tax treatment of a transaction comprising:
determining potential taxes due for a given transaction if the transaction were to be executed in each of a plurality of possible jurisdictions selectable by a user; and
forwarding data regarding execution of the transaction to a computer located in the selected jurisdiction.

2. The method according to claim 1, further comprising calculating any shipping costs due to execution of the transaction in each of the plurality of jurisdictions.

3. The method according to claim 1, further comprising determining any tariffs due if the given transaction were executed in each of the plurality of possible jurisdictions.

4. The method according to claim 1, further comprising executing the transaction in the selected jurisdiction in the computer located in the selected jurisdiction.

5. The method according to claim 1, further comprising enabling the user to select in which one of the plurality of possible jurisdictions to execute the transaction.

6. The method according to claim 1, further comprising ranking each of the jurisdictions based on the determination of potential taxes for the given transaction.

7. The method according to claim 1, further comprising:
determining any tariffs due if the given transaction were executed in each of the plurality of possible jurisdictions;
calculating any shipping costs due to execution of the transaction in each of the plurality of jurisdictions; and
ranking each of the jurisdictions based on a total cost if the given transaction were executed in each of the plurality of jurisdictions, said total cost including at least any potential taxes due, any potential tariffs incurred and any shipping costs that might be incurred.

8. The method according to claim 1, further comprising protecting the anonymity of a plurality of transaction parties by only passing data required for tax purposes together with an an identification token.

9. The emthod according to claim 8, wherein the only passing data required for tax puposes includes sending a less than complete address for identification purposes only.

10. A method for optimizing tax treatment of a transaction comprising:
determining potential taxes due for a given transaction if the transaction were to be executed in each of a plurality of possible jurisdictions; and
matching sides of the transaction in a computer located in a selectable jurisdiction.

11. The method according to claim 10, further comprising selecting by the user in which one of the plurality of possible jurisdictions to execute the transaction.

12. The method according to claim 10, further comprising executing the transaction in the selected jurisdiction in the computer located in the selected jurisdiction.

13. The method according to claim 10, further comprising enabling the user to select in which one of the plurality of possible jurisdictions to execute the transaction.

14. The method according to claim 10, further comprising calculating any shipping costs due to execution of the transaction in each of the plurality of jurisdictions.

15. The method according to claim 10, further comprising determining any tariffs that would be due if the given transaction were to be executed in each of the plurality of possible jurisdictions.

16. The method according to claim 10, further comprising ranking each of the jurisdictions based on the determination of potential taxes that would be due if the given transaction were to be exeucuted in each of the plurality of possible jurisdictions.

17. The method according to claim 10, further comprising:
determining any tariffs that would be due if the given transaction were to be executed in each of the plurality of possible jurisdictions;
calculating any shipping costs that would be due if the given transaction were to be executed in each of the plurality of possible jurisdictions; and
ranking each of the jurisdictions based on a total cost if the given transaction were executed in each of the plurality of possible jurisdictions, said total cost including at least any potential taxes due, any potential tariffs incurred and any shipping costs that might be incurred.

18. An apparatus for optimizing tax treatment of a transaction comprising:
a user interface via which a user enters a proposed transaction and a plurality of jurisdictions in which the transaction may be executed;
a database storing tax rules for a plurality of jurisdictions;
a processor accessing the database to determine taxes that would ensue if a proposed transaction were to be executed in each of a plurality of jurisdictions, and outputting the taxes for each jurisdiction to the user interface.

19. The apparatus according to claim 18, further comprising a plurality of servers accessible by the processor, each of the plurality of servers disposed in one of the plurality of jurisdictions, one server for each of the plurality of jurisdictions, one of said plurality of servers to match two sides of the transaction in a selected jurisdiction upon instructions by the user.

20. The apparatus according to claim 18, wherein said processor determines any tariffs that might be due if the given transaction were executed in each of the plurality of possible jurisdictions.

21. The apparatus according to claim 20, wherein the processor calculates any shipping costs due if the transaction was executed in each of the plurality of jurisdictions.

22. The apparatus according to claim 21, wherein the processor ranks each of the jurisdictions based on a total cost if the given transaction were executed in each of the plurality of jurisdictions, said total cost including at least any potential taxes due, any potential tariffs incurred and any shipping costs that might be incurred.
